(19) United States
(12) Patent Application Publication
(10) Pub. No.: US 2017/0187056 A1
(43) Pub. Date: Jun. 29, 2017

(54) FUEL CELL VEHICLE

(71) Applicant: HONDA MOTOR CO., LTD., Tokyo (JP)

(72) Inventors: Takashi KAWAURA, Wako (JP); Akihiro SUZUKI, Wako (JP); Takeshi OTANI, Wako (JP)

(73) Assignee: HONDA MOTOR CO., LTD., Tokyo (JP)

(21) Appl. No.: 15/353,741

(22) Filed: Nov. 17, 2016

(30) Foreign Application Priority Data
Dec. 24, 2015 (JP) 2015-251916

(51) Int. Cl. H01M 8/04537; B60L 11/18; H01M 8/04082; H01M 8/04664; H01M 8/04746

(52) U.S. Cl. CPC H01M 8/04567; H01M 8/04597; H01M 8/04664; H01M 8/04753; H01M 8/04201; B60L 11/1881; H01M 2250/20

(57) ABSTRACT

A fuel cell vehicle includes a fuel tank, a first detector, a control circuit, and a transmitter. The fuel tank stores fuel gas. The first detector detects information on a state in the fuel tank. The control circuit is configured to receive the information and to generate a signal based on the information. The transmitter includes a transmitter circuit and a response data transmitter circuit. The transmitter circuit is configured to transmit the information to a fuel supply station outside of the fuel cell vehicle according to the signal output from the control circuit. The response data transmitter circuit is configured to transmit response data corresponding to the signal. The control circuit includes a response data receiver circuit to acquire the response data transmitted from the response data transmitter circuit.

### CROSS-REFERENCE TO RELATED APPLICATIONS

The present application claims priority under 35 U.S.C.§119 to Japanese Patent Application No. 2015-251916, filed Dec. 24, 2015, entitled “Fuel Cell Vehicle.” The contents of this application are incorporated herein by reference in their entirety.

### BACKGROUND

1. Field

The present disclosure relates to a fuel cell vehicle.

2. Description of the Related Art

Among systems for filling a fuel cell vehicle with fuel gas, a protocol for filling fuel gas while transmitting information on a fuel cell vehicle to a hydrogen station, this being a fuel gas (hydrogen gas) supply source, is attracting attention (referred to below as a communication filling system). In this communication filling system, supplying fuel gas while the hydrogen station monitors conditions such as the pressure and temperature of a tank on the vehicle-side enables a supply amount and a supply rate of the fuel gas to be controlled so as to enable efficient filling.

The communication filling system has a configuration in which infrared communication is possible between a nozzle on the station side and a receptacle on the fuel cell vehicle side. Specifically, a transmitter element (a light emitting element) that transmits (emits) infrared light is provided to the receptacle, and a receiving element (a light receiving element) that receives (detects) the infrared light is provided to the nozzle, such that information on the vehicle- side hydrogen tank is wirelessly transmitted.

For example, Japanese Unexamined Patent Application Publication No. 2011-33068 describes a gas filling system including a vehicle with a gas tank and a gas station that supplies gas to the gas tank. In this gas supply system, the vehicle is provided with a vehicle-side controller having a filling protocol that stipulates a method of control to be used on the gas station to fill the gas tank. The gas station then controls filling of the gas tank in accordance with the filling protocol specified by the vehicle-side controller.

### SUMMARY

According to a first aspect of the present invention, a fuel cell vehicle includes a fuel cell, a fuel tank, a controller, a communication section, and a drive section. The fuel cell generates power by a reaction between a fuel gas and an oxidizing gas. The fuel tank is capable of storing the fuel gas. The controller acquires information on the fuel tank. The communication section is provided with a transmitter element that transmits the information on the fuel tank to an external station. The drive section drives the communication section using a signal from the controller. At least one of the communication section and the drive section is provided with a response data transmitter that transmits response data responding to content of the signal transmitted from the controller. The controller is provided with a response data receiver that acquires the response data transmitted from the response data transmitter.

According to a second aspect of the present invention, a fuel cell vehicle includes a fuel cell, a fuel tank, a first detector, a control circuit, and a transmitter. The fuel cell generates electric power via a reaction between a fuel gas and an oxidizing gas. The fuel tank stores the fuel gas. The first detector detects information on a state in the fuel tank. The control circuit is configured to receive the information and to generate a signal based on the information. The transmitter includes a transmitter circuit and a response data transmitter circuit. The transmitter circuit is configured to transmit the information to a fuel supply station outside of the fuel cell vehicle according to the signal output from the control circuit. The response data transmitter circuit is configured to transmit response data corresponding to the signal. The control circuit includes a response data receiver circuit to acquire the response data transmitted from the response data transmitter circuit.

According to a third aspect of the present invention, a fuel cell vehicle includes a fuel cell means, a fuel storing means, a detecting means, a control means, and a transmitter. The fuel cell means generates electric power via a reaction between a fuel gas and an oxidizing gas. The fuel storing means stores the fuel gas. The detecting means detects information on a state in the fuel storing means. The control means receives the information and generates a signal based on the information. The transmitter includes a transmitting means and a response data transmitting means. The transmitting means transmits the information to a fuel supply station outside of the fuel cell vehicle according to the signal output from the control means. The response data transmitting means transmits response data corresponding to the signal. The control means includes a response data receiving means for acquiring the response data transmitted from the response data transmitting means.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic perspective view of a fuel cell vehicle according to a first embodiment of the present disclosure.

FIG. 2 is a functional block diagram of the fuel cell vehicle.

FIG. 3 is a detailed functional block diagram of a controller and a vehicle-side communication device of the fuel cell vehicle.

FIG. 4 is a side view illustrating a receptacle and the vehicle-side communication device of the fuel cell vehicle.

FIG. 5 is a front view illustrating the receptacle and the vehicle-side communication device.

FIG. 6 is a flowchart illustrating operation of a fuel cell vehicle according to the first embodiment.

FIG. 7 is a detailed functional block diagram of a fuel cell vehicle according to a second embodiment of the present disclosure.

FIG. 8 is a flowchart illustrating operation of a fuel cell vehicle according to the second embodiment.

FIG. 9 is a detailed functional block diagram of a fuel cell vehicle according to a third embodiment of the present disclosure.

FIG. 10 is a perspective view of a vehicle-side communication device of a fuel cell vehicle according to the third embodiment.

FIG. 11 is a flowchart illustrating operation of a fuel cell vehicle according to the third embodiment.

FIG. 12 is a partial view of a fuel cell vehicle according to a fourth embodiment of the present disclosure.

FIG. 13 is a detailed functional block diagram of a fuel cell vehicle according to a fifth embodiment of the present disclosure.

FIG. 14 is a flowchart illustrating operation of a fuel cell vehicle according to the fifth embodiment.

### DESCRIPTION OF THE EMBODIMENTS

The embodiment(s) will now be described with reference to the accompanying drawings, wherein like reference numerals designate corresponding or identical elements throughout the various drawings.

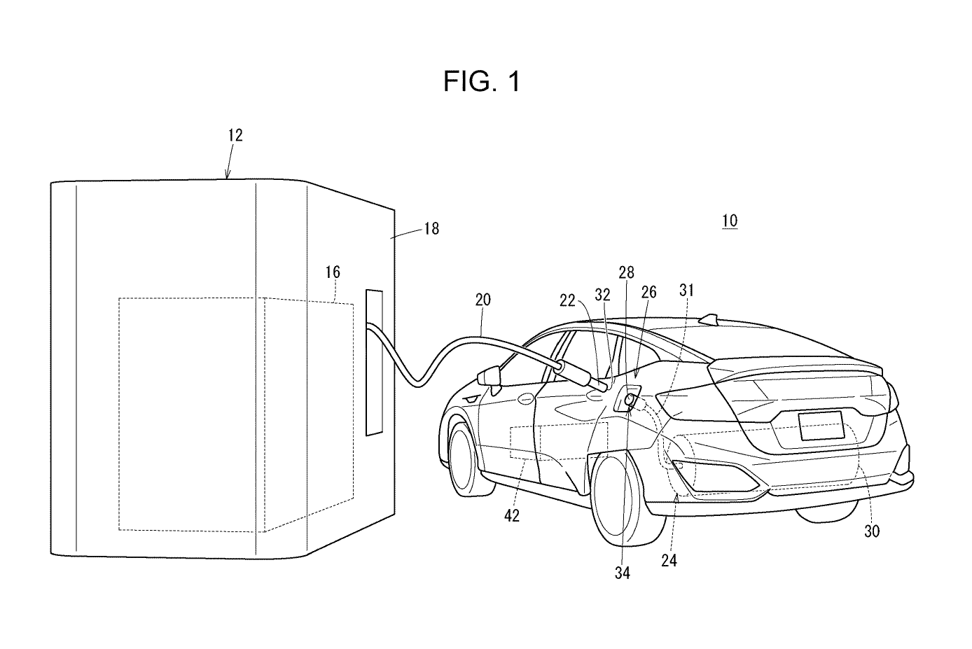

As illustrated in FIG. 1, a fuel cell vehicle 10 according to a first embodiment of the present disclosure is, for example, a fuel cell electric vehicle. The fuel cell vehicle 10 is filled with fuel gas (hydrogen gas) while communicating information with an external station such as a hydrogen station 12.

The hydrogen station 12 is, similarly to a gas station, for example, located next to a road to supply fuel gas. The hydrogen station 12 includes a hydrogen station base unit 18 with a built-in supply-side hydrogen tank 16 for storing fuel gas; a hose 20 having one end connected to the supply-side hydrogen tank 16; and a nozzle 22 that is connected to the other end of the hose 20. The nozzle 22 is capable of being connected to a receptacle 28 of the fuel cell vehicle 10, described below, to fill the fuel cell vehicle 10 with fuel gas.

The fuel cell vehicle 10 is installed with a fuel cell system 24 that uses an electrochemical reaction between the fuel gas and an oxidizing gas (for example, air) to generate power. The fuel cell vehicle 10 runs using the fuel cell system 24 as a motive power source. A fuel introduction box 26 for introducing fuel gas into the fuel cell vehicle 10 is provided to a rear side portion of a body of the fuel cell vehicle 10. The receptacle 28 that is capable of being connected to the nozzle 22 described above is disposed in the fuel introduction box 26.

The receptacle 28 is connected to a vehicle-side hydrogen tank (fuel tank) 30 inside the fuel cell vehicle 10 through fuel gas distribution piping 31. The vehicle-side hydrogen tank 30 is, for example, disposed at the rear side of the fuel cell vehicle 10.

The communications line between the hydrogen station 12 and the fuel cell vehicle 10 is a wireless connection (infrared communication) formed between a supply-side communication device 32 provided to a leading end of the nozzle 22 and a vehicle-side communication device 34 provided adjacent to the receptacle 28.

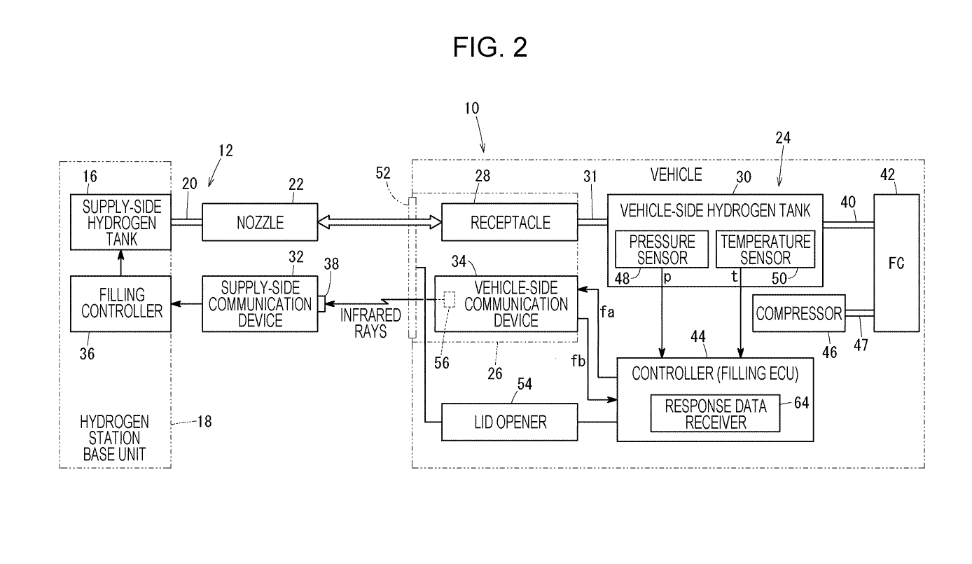

As illustrated in FIG. 2, the hydrogen station base unit 18 includes the supply-side hydrogen tank 16 and a filling controller 36 that controls the hydrogen station 12. The filling controller 36 monitors a storage state of the fuel gas inside the supply-side hydrogen tank 16, detects a state of connection between the fuel cell vehicle 10 and the nozzle 22, and controls filling of the fuel gas such as by ON/OFF control. The filling controller 36 includes functionality to recognize (monitor) a state of the vehicle-side hydrogen tank 30 and to control a supply amount and a supply rate of fuel gas when filling the fuel gas.

The supply-side communication device 32 provided to the nozzle 22 of the hydrogen station 12 is electrically connected to the filling controller 36. The supply-side communication device 32 includes plural light receiving elements (receiving elements) 38 that receive infrared rays and convert the infrared rays into current signals, and an electric circuit, not illustrated in the drawings, that converts the current signals of the light receiving elements 38 into voltage signals, amplifies the signals, and sends the voltage signals to the filling controller 36. Various devices capable of receiving infrared rays (wireless signals) may be applied as the light receiving elements 38. For example, photodiodes (PD) may be employed.

The fuel cell system 24 installed in the fuel cell vehicle 10 includes the vehicle-side hydrogen tank 30, a fuel cell 42 that connects to a fuel gas supply system of the vehicle-side hydrogen tank 30 through a fuel gas flow path 40, and a controller (filling ECU) 44.

The fuel cell 42 is, for example, disposed at the front side (in the motor compartment) of the fuel cell vehicle 10 (see FIG. 1). Plural power generation cells are stacked in the fuel cell 42, and the fuel cell 42 uses a supply of fuel gas from the vehicle-side hydrogen tank 30 and a supply of oxidizing gas (compressed air) from a compressor 46 to generate power. The compressor 46 and an oxidizing gas supply system of the fuel cell 42 are coupled together through an oxidizing gas flow path 47.

A pressure sensor 48 that detects a pressure of gas inside the vehicle-side hydrogen tank 30 and outputs a pressure value p, and a temperature sensor 50 that detects a temperature of gas inside the vehicle-side hydrogen tank 30 and outputs a temperature value t, are provided to the vehicle-side hydrogen tank 30. The pressure sensor 48 and the temperature sensor 50 are electrically connected to the controller 44, and transmit respective detection signals of the pressure value p and the temperature value t to the controller 44. The controller 44 monitors a state of fuel gas filled in the vehicle-side hydrogen tank 30.

The controller 44 includes a CPU, memory, an interface, a timer (none of which are illustrated in the drawings), and the like, and performs processing according to a specific program. The controller 44 performs processing such as processing to encode (convert into a signal) the pressure value p from the pressure sensor 48 and the temperature value t from the temperature sensor 50 as state information of the vehicle-side hydrogen tank 30 receivable by the hydrogen station 12 (referred to below as transmission information fa), and processing to output the state information to the vehicle-side communication device 34.

The receptacle 28 and the vehicle-side communication device 34 are housed inside the fuel introduction box 26 of the fuel cell vehicle 10, and the fuel introduction box 26 is normally closed off by a lid 52, when fuel gas is not being filled. The lid 52 is mechanically connected to a lid opener 54 that opens and closes the lid 52, and driving of the opening and closing of the lid opener 54 is controlled by the controller 44.

A detection sensor (not illustrated in the drawings) that detects a state of connection between the nozzle 22 and the receptacle 28 and sends a detection signal to the controller 44 is preferably provided to the fuel introduction box 26. The controller 44 recognizes the connection of the nozzle 22 to the receptacle 28 based on the detection result by the detection sensor, opens and closes a valve, not illustrated in the drawings, provided to the fuel gas distribution piping 31, and generates and outputs the transmission information fa.

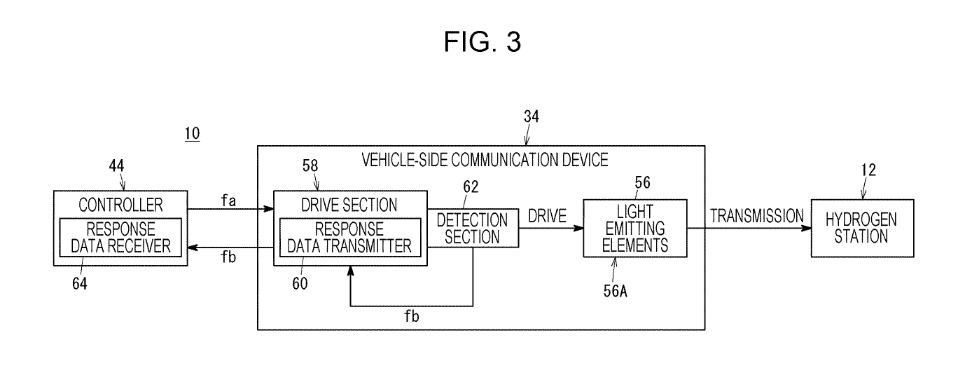

As illustrated in FIG. 3, the vehicle-side communication device 34 includes a communication section 56A provided with plural, for example two, light emitting elements 56, these being light transmitter elements, that transmit information on the vehicle-side hydrogen tank 30 to the hydrogen station 12. The light emitting elements 56 may suitably employ light emitting photodiodes (LEDs) that emit infrared rays of a specific wavelength.

The vehicle-side communication device 34 includes a drive section 58 that drives the communication section 56A using the transmission information fa (signal) from the controller 44, and the drive section 58 is provided with a response data transmitter 60 that transmits response data fb responding to the content of the transmission information fa.

The drive section 58 includes a detection section 62 that detects a drive voltage or a drive current from the drive section 58 applied to the communication section 56A based on the transmission information fa sent from the controller 44. The response data transmitter 60 acquires the drive voltage or the drive current detected by the detection section 62 as the response data fb. The controller 44 is provided with a response data receiver 64 that acquires the response data fb transmitted from the response data transmitter 60.

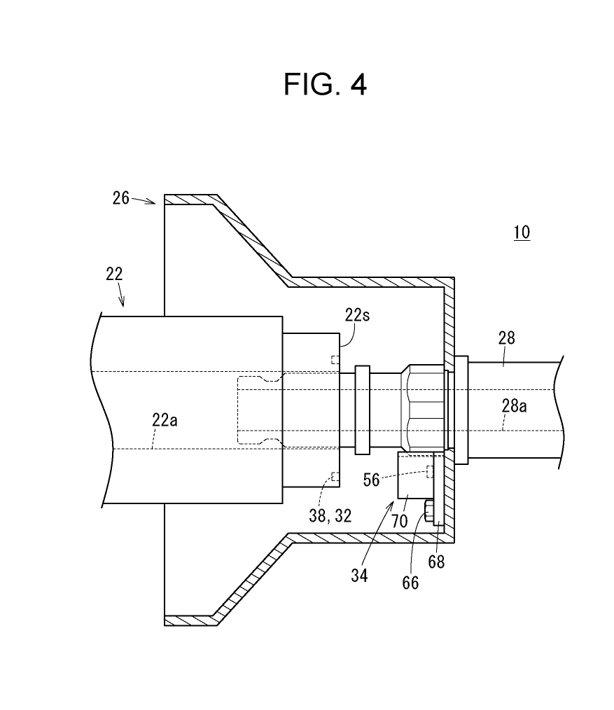

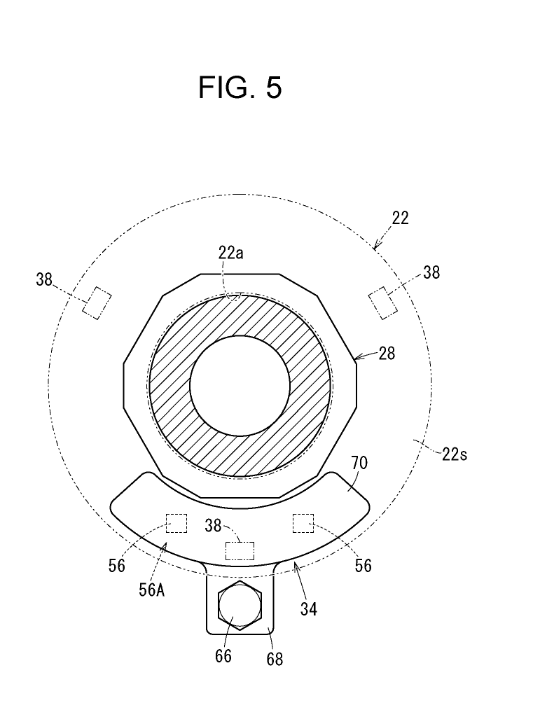

As illustrated in FIG. 4 and FIG. 5, the receptacle 28 and the vehicle-side communication device 34 are disposed inside the fuel introduction box 26 in a state of no mutual direct contact (non-contacting). Note that the receptacle 28 and the vehicle-side communication device 34 are not limited to a configuration in which they are attached to separate bodies. For example, the vehicle-side communication device 34 may be attached to the receptacle 28 and assembled to the fuel introduction box 26 as a unit together with the receptacle 28.

The receptacle 28 is formed from a metal material into a cylindrical shape, and projects to a specific length from a bottom wall of the fuel introduction box 26 toward the outside of the fuel cell vehicle 10. The receptacle 28 is fixed to the bottom wall of the fuel introduction box 26. The vehicle-side communication device 34 is fixed to the bottom wall of the fuel introduction box 26 by a bolt 66. The vehicle-side communication device 34 includes an attachment plate 68 into which the bolt 66 is inserted, and a circular arc shaped case member 70 mounted to the attachment plate 68. The two light emitting elements 56 are disposed inside the case member 70.

The nozzle 22 is formed in a cylindrical shape of a slightly larger size than the receptacle 28. Plural light receiving elements 38 that configure the supply-side communication device 32 are embedded in a leading end face 22s of the nozzle 22 with their infrared ray receiving faces flush with the leading end face 22s. In a state in which the nozzle 22 and the receptacle 28 are connected, a supply-side flow path 22a of the nozzle 22 and a vehicle-side flow path 28a of the receptacle 28 are coupled together.

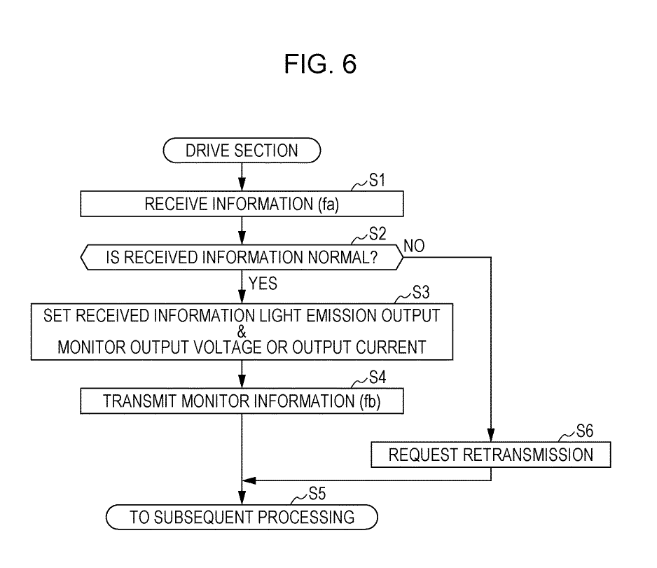

Description follows regarding operation of the fuel cell vehicle 10 configured in such a manner, with reference to the flowchart illustrated in FIG. 6.

When filling fuel gas into the fuel cell vehicle 10, the fuel cell vehicle 10 is brought close to the hydrogen station 12, and the lid opener 54 is driven by specific operation so as to open the lid 52 and expose the fuel introduction box 26. Then, the nozzle 22 and the receptacle 28 are fitted together so as to dispose the vehicle-side communication device 34 (the light emitting elements 56) and the supply-side communication device 32 (the light receiving elements 38) at a separation where infrared communication is possible.

Next, after connecting the nozzle 22 and the receptacle 28 together, the filling of fuel gas into the fuel cell vehicle 10 is commenced. Fuel gas is guided from the supply-side hydrogen tank 16 to the nozzle 22 through the hose 20, and the fuel gas is introduced into the vehicle-side flow path 28a of the receptacle 28 from the supply-side flow path 22a of the nozzle 22 (see FIG. 4).

As illustrated in FIG. 2, the fuel gas is supplied from the receptacle 28, through the fuel gas distribution piping 31, to the vehicle-side hydrogen tank 30 where it is stored. The fuel gas is filled into the vehicle-side hydrogen tank 30 until the fuel gas reaches a specific amount (for example, an amount when the gas pressure reaches 35 MPa), however, a temperature increase occurs during filling as the internal pressure of the vehicle-side hydrogen tank 30 rises. The pressure sensor 48 and the temperature sensor 50 provided to the vehicle-side hydrogen tank 30 respectively detect the pressure and temperature of the vehicle-side hydrogen tank 30, and output the pressure value p and the temperature value t to the controller 44.

As illustrated in FIG. 3, the controller 44 generates transmission information fa from the pressure value p and temperature value t, and outputs the transmission information fa to the drive section 58 of the vehicle-side communication device 34. The drive section 58 receives the transmission information fa (step S1 in FIG. 6), and determines whether or not the received transmission information fa is normal (step S2).

If the received information is determined to be normal (YES in step S2), processing transitions to step S3, an emission output of each of the light emitting elements 56 is set based on the transmission information fa, and infrared rays are emitted from the light emitting elements 56 toward the light receiving elements 38. When this occurs, as illustrated in FIG. 3, an output voltage or an output current of the light emitting elements 56 is detected by the detection section 62. The detection section 62 sends the detected output voltage or output current to the drive section 58.

The response data transmitter 60 thereby acquires the detected output voltage or output current as the response data (monitor information) fb, and transmits the response data fb to the controller 44 (step S4). The transmission information fa sent to the drive section 58 and the response data fb transmitted from the response data transmitter 60 are compared in the controller 44, and processing transitions to subsequent processing based on the comparison result (step S5).

However, if the received information is determined not to be normal at step S2 (NO in step S2), processing transitions to step S6, and the controller 44 causes the transmission information fa to be retransmitted. Processing then transitions to step S5, and transitions to subsequent processing.

For such a case, in the first embodiment, as illustrated in FIG. 3, the drive section 58 is provided with the response data transmitter 60 that transmits, to the controller 44, the response data fb responding to the content of the transmission information fa transmitted from the controller 44. Then, the response data fb is transmitted to the controller 44 such that the controller 44 acquires the response data fb.

Note that the response data receiver 64 acquires the drive voltage or the drive current detected by the detection section 62 as the response data fb. Accordingly, abnormalities in drive signal transmission from the controller 44 up to the communication section 56A can be easily and accurately distinguished when transmitting information on the vehicle-side hydrogen tank 30 to an external hydrogen station 12. An effect of enabling good acquisition of the content of the transmission information fa at the vehicle side, and enabling reliable suppression of abnormal transmissions to the hydrogen station 12 can thereby be obtained.

As illustrated in FIG. 2, in the hydrogen station 12 the transmission information fa is acquired and transmitted to the filling controller 36 by the supply-side communication device 32 including the light receiving elements 38 receiving infrared rays from the communication section 56A.

The filling controller 36 regulates the supply amount and the supply rate of the fuel gas during filling based on this transmission information fa. It is thereby possible to supply fuel gas in accordance with a state of the vehicle-side hydrogen tank 30, and effective filling of the fuel gas is enabled.

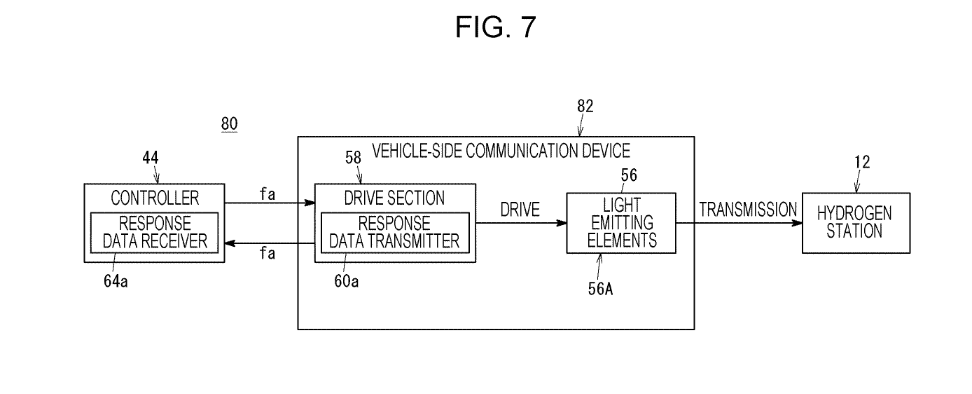

FIG. 7 is a detailed functional block diagram of a fuel cell vehicle 80 according to a second embodiment of the present disclosure. Note that configuration elements similar to those of the fuel cell vehicle 10 according to the first embodiment are appended with the same reference numerals, and detailed description thereof is omitted. In the third, and subsequent, embodiments explained below, configuration elements similar to those of the fuel cell vehicle 10 according to the first embodiment are also appended with the same reference numerals, and detailed description thereof is omitted.

The fuel cell vehicle 80 includes a vehicle-side communication device 82. The vehicle-side communication device 82 includes the drive section 58 that drives a communication section 56A using the transmission information fa from the controller 44, and the drive section 58 is provided with a response data transmitter 60a that transmits transmission information (response data) fa having the same content as the transmission information fa. The controller 44 is provided with a response data receiver 64a that acquires the transmission information fa transmitted from the response data transmitter 60a.

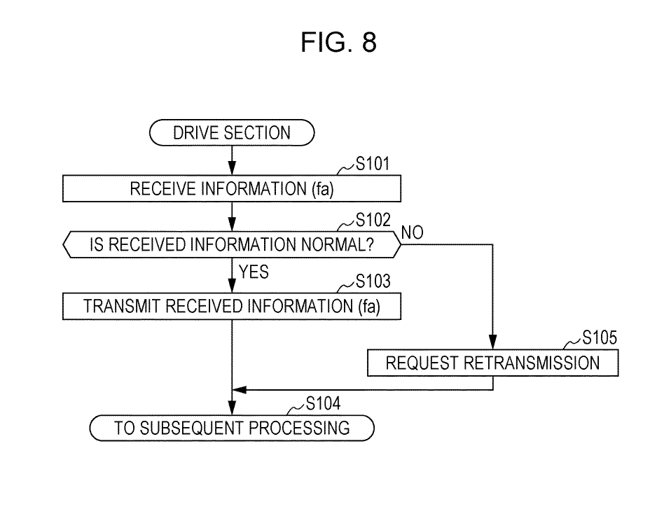

Description follows regarding operation of the fuel cell vehicle 80 configured in such a manner, with reference to the flowchart illustrated in FIG. 8. Note that detailed description of processing similar to that of the flowchart according to the first embodiment illustrated in FIG. 6 is omitted.

The drive section 58 receives transmission information fa output from the controller 44 (step S101), and processing transitions to step S103 if the transmission information fa is determined to be normal (YES in step S102). At step S103, the transmission information fa is transmitted from the response data transmitter 60a of the drive section 58 to the response data receiver 64a of the controller 44.

The transmission information fa sent to the drive section 58 and the transmission information fa transmitted from the response data transmitter 60a are accordingly compared in the controller 44, and processing transitions to subsequent processing based on the comparison result (step S104).

Accordingly, abnormalities between the controller 44 and the drive section 58 when transmitting information on the vehicle-side hydrogen tank 30 to an external hydrogen station 12 can be easily and accurately distinguished in the second embodiment. This thereby enables the content of the transmission information fa to be acquired at the vehicle side, and enables an effect of enabling abnormal transmissions to the hydrogen station 12 to be reliably suppressed to be obtained.

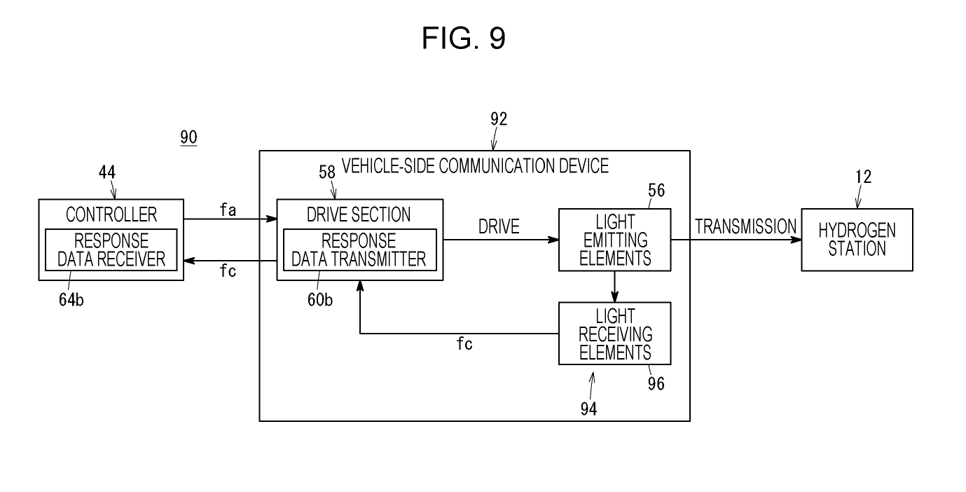

FIG. 9 is a detailed functional block diagram of a fuel cell vehicle 90 according to a third embodiment of the present disclosure.

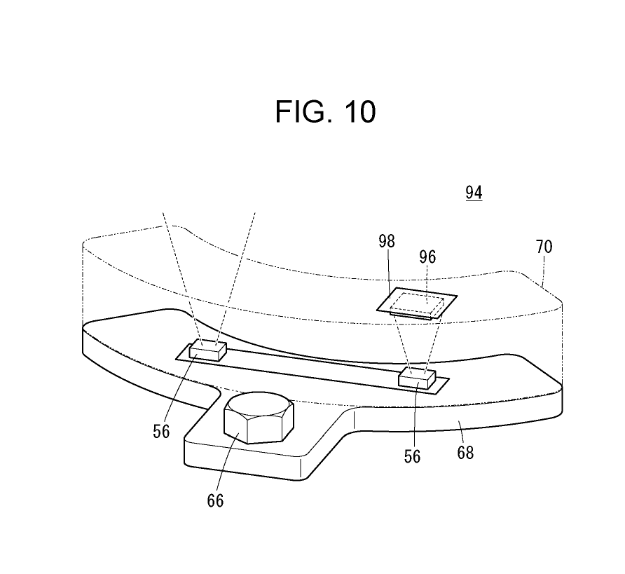

The fuel cell vehicle 90 includes a vehicle-side communication device 92. The vehicle-side communication device 92 includes a communication section 94 that is driven by a drive voltage or a drive current applied thereto from the drive section 58 using the transmission information fa from the controller 44. As illustrated in FIG. 9 and FIG. 10, the communication section 94 includes, for example, two light emitting elements 56 and a light receiving element 96 disposed at a front face of one of the light emitting elements 56. The light receiving element 96 is connected to a light receiving element substrate 98. The light receiving element substrate 98 is housed inside the case member 70, and is connected to the drive section 58.

The drive section 58 acquires response data fc, this being information (emitted signals) received by the light receiving element 96, and the drive section 58 includes a response data transmitter 60b that transmits the response data fc to the controller 44. The controller 44 is provided with a response data receiver 64b that acquires the response data fc transmitted from the response data transmitter 60b.

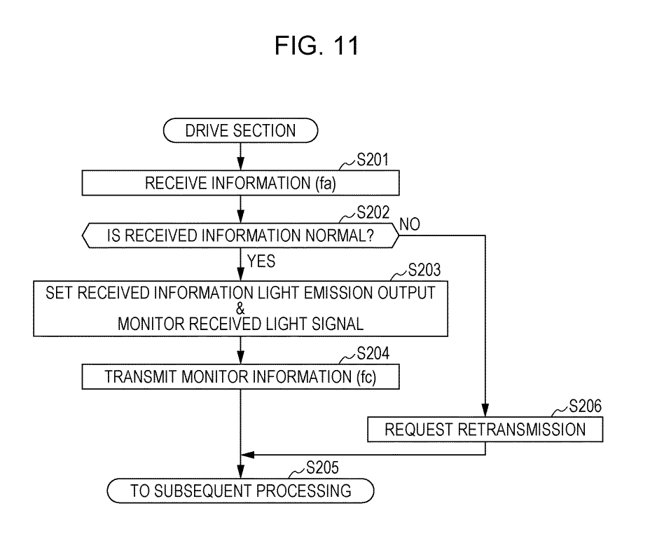

Description follows regarding operation of the fuel cell vehicle 90 configured in such a manner, with reference to the flowchart illustrated in FIG. 11. Note that detailed description of processing similar to that of the flowchart according to the first embodiment illustrated in FIG. 6 is omitted.

The drive section 58 receives transmission information fa output from the controller 44 (step S201), and processing transitions to step S203 if the drive section 58 determines that the transmission information fa is normal (YES in step S202). At step S203, emission output of the respective light emitting elements 56 is set based on the transmission information fa. Infrared rays are emitted from one of the light emitting elements 56 toward the light receiving elements 38 on the station, and infrared rays are emitted from another of the light emitting elements 56 toward the light receiving element 96 on the vehicle.

Information (transmission information fa) radiated to the light receiving elements 38 of the hydrogen station 12 can therefore be monitored at the light receiving element 96. The information radiated to the light receiving element 96 is transmitted to the response data transmitter 60b of the drive section 58. The response data transmitter 60b acquires the transmitted information as the response data fc, and transmits the response data fc to the response data receiver 64b of the controller 44 (step S204).

Thus, as the light receiving element 96 on the vehicle receives the signal (information) that has been transmitted from the communication section 94 to the hydrogen station 12, whether or not an abnormal signal has been transmitted from the vehicle can be precisely determined in the third embodiment. An effect of enabling abnormal transmissions to the hydrogen station 12 to be reliably suppressed can thereby be obtained.

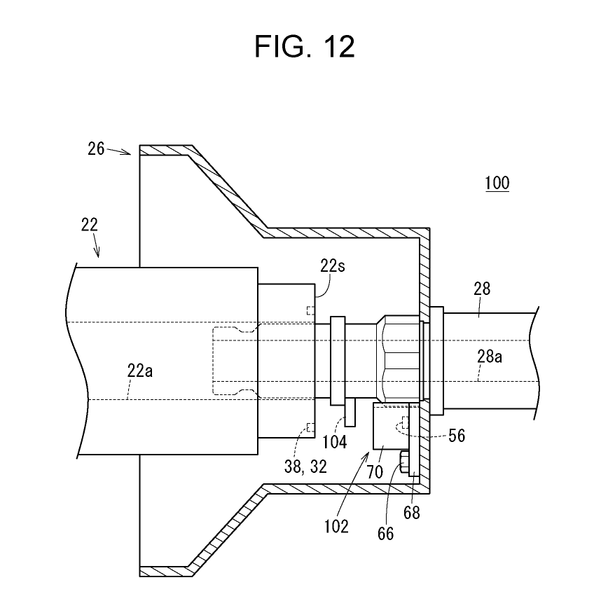

FIG. 12 is a partial view of a fuel cell vehicle 100 according to a fourth embodiment of the present disclosure.

The fuel cell vehicle 100 includes a communication section 102 in place of the communication section 94 adopted in the third embodiment. The communication section 102 includes, for example, two light emitting elements 56 and a light receiving element 104 disposed at a front face of one of the light emitting elements 56. The light receiving element 104 is attached away from the case member 70, for example, to the receptacle 28.

Effects similar to those of the third embodiment above can be obtained in the fourth embodiment configured in such a manner.

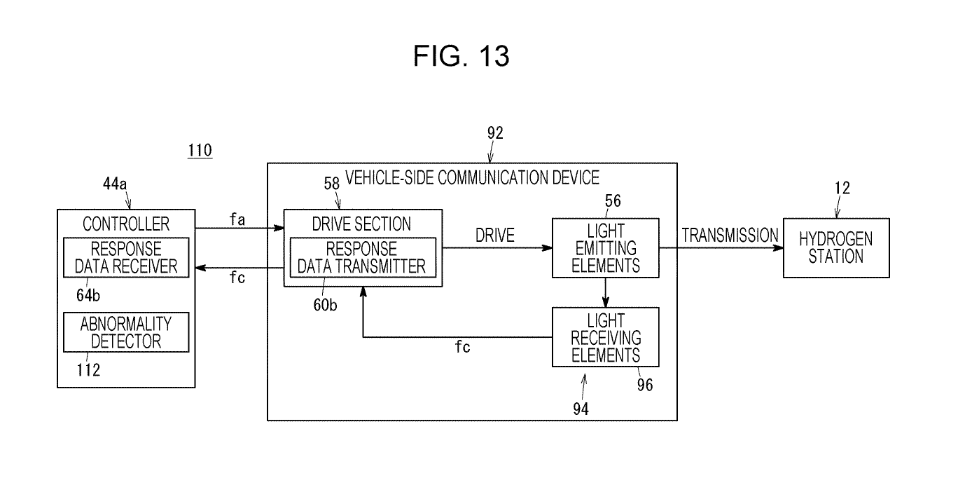

FIG. 13 is a detailed functional block diagram of a fuel cell vehicle 110 according to a fifth embodiment of the present disclosure.

The fuel cell vehicle 110 includes a controller 44a, and the controller 44a includes an abnormality detector 112 that detects the presence of an abnormality based on the response data fc acquired by the response data receiver 64b.

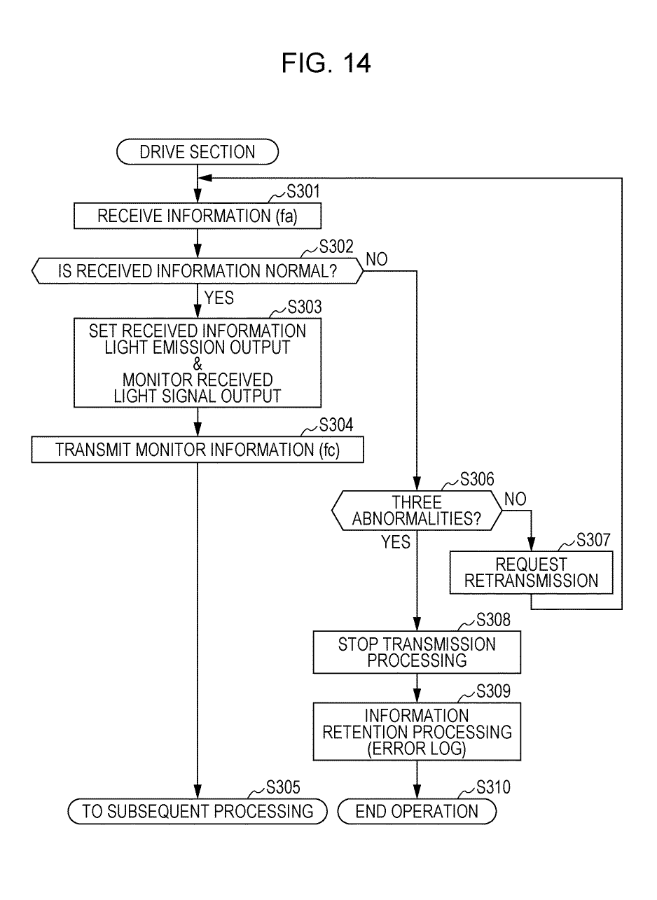

Description follows regarding operation of the fuel cell vehicle 110 configured in such a manner, with reference to the flowchart illustrated in FIG. 14. Note that detailed description of processing similar to that of the flowchart according to the third embodiment illustrated in FIG. 11 is omitted.

Steps S301 to S305 are performed similarly to steps S201 to S205 of the third embodiment. If the transmission information fa is determined not to be normal at step S302 (NO in step S302), processing transitions to step S306, and determination is then made as to whether or not there have been three occurrences of abnormalities. If it is determined that there have not been three occurrences of abnormalities (NO in step S306), processing transitions to step S307, and the transmission information fa is retransmitted to the controller 44a.

However, if it is determined that there have been three occurrences of abnormalities (YES in step S306), processing transitions to step S308, and transmission processing from the communication section 94 is stopped. Moreover, processing then transitions to step S309, and, after performing processing to save the information, filling processing of the fuel gas using information communication is stopped (step S310), and a signal to switch to normal filling processing is sent. Vehicle-side filling processing is therefore stopped.

Thus in the fifth embodiment, since communication filling is stopped due to an abnormal state being established, problems when filling fuel gas into the fuel cell vehicle 110 are suppressed as much as possible and the implementation of excellent filling processing is enabled. Note that although the abnormality detector 112 is incorporated into the third embodiment in the fifth embodiment, there is no limitation thereto, and the abnormality detector 112 may be incorporated into the first, second, or fourth embodiments.

The present disclosure is not limited to the fuel cell vehicle 10 and the like according to the embodiments described above, and a variety of configurations may be adopted. For example, configuration may be such that a transmitter element is provided to the supply-side communication device 32 (on the nozzle 22 side), a receiving element is provided to the vehicle-side communication device 34 (on the fuel cell vehicle 10 side), and information of the hydrogen station 12 is sent to the fuel cell vehicle 10.

According to one aspect of the present disclosure, a fuel cell that generates power by a reaction between a fuel gas and an oxidizing gas, and a fuel tank that is capable of storing the fuel gas. The fuel cell vehicle further includes a controller that acquires information on the fuel tank, a communication section provided with a transmitter element that transmits the information on the fuel tank to an external station, and a drive section that drives the communication section using a signal from the controller.

At least one of the communication section and the drive section is provided with a response data transmitter that transmits response data responding to content of the signal transmitted from the controller. The controller is provided with a response data receiver that acquires the response data transmitted from the response data transmitter.

In the fuel cell vehicle, it is preferable that the response data transmitter be provided to the drive section and transmit the signal transmitted from the controller to the response data receiver as the response data.

It is preferable that the fuel cell vehicle further include a detector that detects a drive voltage or a drive current applied to the communication section from the drive section based on the signal transmitted from the communication section. When this occurs, it is preferable that the response data receiver acquire the drive voltage or the drive current detected by the detector as the response data.

In the fuel cell vehicle, it is preferable that the communication section be provided with the transmitter element driven by the controller, and a receiving element that receives the transmission signal transmitted from the transmitter element. In such cases it is preferable that the response data receiver acquire the transmission signal received by the receiving element as the response data.

It is preferable that a receptacle for connecting to a nozzle of the external station be provided to a fuel gas filling port of the fuel cell vehicle, and that the receiving element be provided on the receptacle within a range capable of receiving the transmission signal from the transmitter element.

It is preferable that the fuel cell vehicle further include an abnormality detector that detects the presence of an abnormality based on the response data acquired by the response data receiver. In such cases, it is preferable that the controller cause the communication section to stop transmission to the external station when an abnormality has been detected by the abnormality detector.

According to the present disclosure, at least one of the communication section and the drive section transmits, to the controller, the response data responding to the content of the signal transmitted from the controller such that the controller acquires the response data. Accordingly, the information transmitted can be acquired at the vehicle side, and abnormal transmissions to the external station can be reliably suppressed, when transmitting information on the fuel tank from the vehicle to the external station.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell vehicle comprising:
a fuel cell that generates power by a reaction between a fuel gas and an oxidizing gas;
a fuel tank that is capable of storing the fuel gas;
a controller that acquires information on the fuel tank;
a communication section provided with a transmitter element that transmits the information on the fuel tank to an external station; and
a drive section that drives the communication section using a signal from the controller; wherein
at least one of the communication section and the drive section is provided with a response data transmitter that transmits response data responding to content of the signal transmitted from the controller, and
the controller is provided with a response data receiver that acquires the response data transmitted from the response data transmitter.

2. The fuel cell vehicle according to claim 1, wherein the response data transmitter is provided to the drive section and transmits the signal transmitted from the controller to the response data receiver as the response data.

3. The fuel cell vehicle according to claim 1, further comprising:
a detector that detects a drive voltage or a drive current applied to the communication section from the drive section based on the signal transmitted from the communication section; wherein
the response data receiver acquires the drive voltage or the drive current detected by the detector as the response data.

4. The fuel cell vehicle according to claim 1, wherein
the communication section is provided with the transmitter element driven by the controller, and a receiving element that receives the transmission signal transmitted from the transmitter element, and
the response data receiver acquires the transmission signal received by the receiving element as the response data.

5. The fuel cell vehicle according to claim 4, wherein
a receptacle for connecting to a nozzle of the external station is provided to a fuel gas filling port of the fuel cell vehicle, and
the receiving element is provided on the receptacle within a range capable of receiving the transmission signal from the transmitter element.

6. The fuel cell vehicle according to claim 1, further comprising:
an abnormality detector that detects the presence of an abnormality based on the response data acquired by the response data receiver; wherein
the controller causes the communication section to stop transmission to the external station when an abnormality has been detected by the abnormality detector.

7. A fuel cell vehicle comprising:
a fuel cell to generate electric power via a reaction between a fuel gas and an oxidizing gas;
a fuel tank to store the fuel gas;
a first detector to detect information on a state in the fuel tank;
a control circuit configured to receive the information and to generate a signal based on the information;
a transmitter comprising:
a transmitter circuit configured to transmit the information to a fuel supply station outside of the fuel cell vehicle according to the signal output from the control circuit; and
a response data transmitter circuit configured to transmit response data corresponding to the signal; and
the control circuit including a response data receiver circuit to acquire the response data transmitted from the response data transmitter circuit.

8. The fuel cell vehicle according to claim 7, wherein the transmitter circuit comprises
a transmitter element to transmit the information to the fuel supply station, and
a driver to drive the transmitter element according to the signal output from the control circuit,
wherein at least one of the transmitter element and the driver includes the response data transmitter circuit.

9. The fuel cell vehicle according to claim 8, wherein the response data transmitter circuit is provided to the driver and transmits the signal transmitted from the control circuit to the response data receiver circuit as the response data.

10. The fuel cell vehicle according to claim 8, further comprising:
a second detector that detects a drive voltage or a drive current applied to the transmitter from the driver based on the signal transmitted from the control circuit; wherein
the response data receiver circuit acquires the drive voltage or the drive current detected by the second detector as the response data.

11. The fuel cell vehicle according to claim 8, wherein
the transmitter is provided with the transmitter element driven by the control circuit, and a receiving element that receives the transmission signal transmitted from the transmitter element, and
the response data receiver circuit acquires the transmission signal received by the receiving element as the response data.

12. The fuel cell vehicle according to claim 11, wherein
a receptacle for connecting to a nozzle of the fuel supply station is provided to a fuel gas filling port of the fuel cell vehicle, and
the receiving element is provided on the receptacle within a range capable of receiving the transmission signal from the transmitter element.

13. The fuel cell vehicle according to claim 7, further comprising:
an abnormality detector that detects the presence of an abnormality based on the response data acquired by the response data receiver circuit; wherein
the control circuit causes the transmitter to stop transmission to the fuel supply station when an abnormality has been detected by the abnormality detector.

14. A fuel cell vehicle comprising:
a fuel cell means for generating electric power via a reaction between a fuel gas and an oxidizing gas;
a fuel storing means for storing the fuel gas;
a detecting means for detecting information on a state in the fuel storing means;
a control means for receiving the information and for generating a signal based on the information;
a transmitter comprising:
a transmitting means for transmitting the information to a fuel supply station outside of the fuel cell vehicle according to the signal output from the control means; and
a response data transmitting means for transmitting response data corresponding to the signal; and
the control means including a response data receiving means for acquiring the response data transmitted from the response data transmitting means.
